(19) United States
(12) Patent Application Publication
(10) Pub. No.: US 2025/0089148 A1
(43) Pub. Date: Mar. 13, 2025

(54) ELIMINATING MIRROR SYMMETRY AND GRAVITY AMBIGUITY FROM A 2D MESH OF DEVICES

(71) Applicant: SIGNIFY HOLDING B.V., EINDHOVEN (NL)

(72) Inventor: TEWE HIEPKE HEEMSTRA, VELDHOVEN (NL)

(21) Appl. No.: 18/726,490

(22) PCT Filed: Dec. 22, 2022
(86) PCT No.: PCT/EP2022/087416

§ 371 Date: Jul. 3, 2024

(30) Foreign Application Priority Data
Jan. 6, 2022 (EP) 22150423.6

(51) Int. Cl. H05B 47/195; G01S 5/02; G01S 5/16; H05B 47/175

(52) U.S. Cl. CPC H05B 47/195; G01S 5/0289; G01S 5/16; H05B 47/1995

(57) ABSTRACT

A mechanism for handling mirror symmetry and gravity ambiguity in a two-dimensional mesh of devices. A direction of gravity with respect to a first device, of a trio of devices, is determined by a gravitational sensor comprised in the first device. A relative direction of a second and third device with respect to the first device is then ascertained. The direction of gravity, and the relative directions of the first and third device, are then used to determine a handedness of a triangle connecting the three devices with respect to gravity. This handedness with respect to gravity can be propagated throughout the mesh of devices and used to eliminate mirror symmetry and gravity ambiguity in the mesh.

### FIELD OF THE INVENTION

The present invention relates to the field of device commissioning, and in particular to determining the orientation of a set of devices with respect to gravity.

### BACKGROUND OF THE INVENTION

The introduction of smart devices, such as luminaires or lamps, into a wide variety of environments (e.g. domestic, industrial or clinical) is becoming of increasing interest. It is usual to try to define a mesh or network that defines the relative location of devices with respect to one another. In particular, it will be appreciated that devices can form a hypothetical mesh of devices, each device representing a node of the mesh. Determining information about this mesh aids in appropriate control of devices as a collective and/or individually, e.g. to know how to optimally route communications to a particular device, or how to control the mesh of devices to create a desired, collective output.

Commissioning of devices is typically a tedious process. This is because an individual usually has to tell a system where the devices are, e.g. by pointing a remote control to a luminaire and waiting until it blinks, or by very accurate bookkeeping of which device goes where. It would be advantageous to facilitate automation of this process.

Automatic commissioning processes are in development, in which it is possible to retrieve the shape of the mesh of devices (of which each device forms a node), based on RSSI, time of flight, or similar distance-responsive measures between the devices. However, these approaches still leave a number of degrees of freedom for defining the position and orientation of the mesh (and therefore each device) in absolute space. See for example US20100231404A1.

There is therefore a desire to facilitate automated acquisition of additional properties of the mesh of devices and/or the devices themselves.

### SUMMARY OF THE INVENTION

The invention is defined by the claims.

According to examples in accordance with an aspect of the invention, there is provided a computer-implemented method for defining the handedness, with respect to gravity, of a hypothetical triangle connecting a set of three devices.

The computer-implemented method comprises, defining a direction of gravity with respect to the first device from a gravitational sensor associated with the first device and comprised by the first device; obtaining, from an electromagnetic detector arrangement associated with the first device of the set of three devices: a first indicator that indicates the relative direction of a second device, of the set of three devices, with respect to the first device, wherein the second device is configured to output electromagnetic energy detectable by the electromagnetic detector arrangement; and a second indicator that indicates the relative direction of a third device with respect to the first device, wherein the third device is configured to output electromagnetic energy detectable by the electromagnetic detector arrangement; and defining the handedness of the hypothetical triangle with respect to gravity by processing the direction of gravity with respect to the first device, the first indicator and the second indicator.

A handedness or chirality of a triangle connecting three devices, with respect to gravity, facilitates identification of the orientation of the triangle (and thereby a mesh containing the triangle) with respect to gravity. The handedness with respect to gravity is a handedness with respect to a view from a position vertically above the triangle and looking in the direction of gravity. This reduces a number of degrees of freedom left unidentifiable by automatic commissioning processes for commissioning a mesh containing the three devices.

In the context of the present disclosure, the hypothetical triangle is defined by a path that starts at the first device, moves to the second device, moves to the third device before reverting back to the first device. A handedness of the hypothetical triangle defines whether this path moves clockwise or counter-clockwise within a plane containing the triangle.

The present disclosure proposes an approach in which the handedness of the hypothetical triangle (connecting the three devices) is defined or determined with respect to gravity. This facilitates identification of a missing feature of existing commissioning approaches.

Hence, in aspects, the defined and/or determined handedness, as defined in the present application, may be used and/or implemented in an auto-commissioning process associated with the set of three devices. For example, a processing system arranged for auto-commissioning said set of three devices may be configured to receive or retrieve said handedness for commissioning said set of three devices.

Hence, in aspects of the invention, only the first device may comprise the gravitational sensor, which gravitational sensor defines a direction of gravity with respect to the first device.

Optionally, the second and third devices each comprises one or more light emitting elements and the electromagnetic detector arrangement associated with the first device is a light sensitive arrangement. The electromagnetic detector may be a photodiode arrangement.

The second and third devices may each comprise one or more radio frequency emitting elements and the electromagnetic detector arrangement associated with the first device may be a radio sensitive arrangement.

The second and third devices may each comprise one or more microwave frequency emitting elements and the electromagnetic detector arrangement with the first device may be a microwave sensitive arrangement.

In some examples, the electromagnetic detector arrangement associated with a first device comprises a set of three or more electromagnetic detectors configured or positioned to have a different angular response, so that the magnitude of a measurement of incoming electromagnetic energy emitted from a same source is different for each electromagnetic detector.

Optionally, both the second device and third device are configured to be operable to output a unique, to the set of three devices, electromagnetic energy pattern and/or frequency and the electromagnetic detector arrangement is configured to distinguish the electromagnetic patterns and/or frequencies from one another.

In some examples, each device is configured to output visible light and each unique electromagnetic energy pattern and/or frequency comprises a unique, to the set of three devices, optically encoded message.

In some examples, both the second device and third device are configured to be operable in at least two modes, including: a commissioning mode, in which the device outputs the unique, to the set of three devices, electromagnetic energy pattern and/or frequency; and a run mode, in which the device is able to not output the unique, to the set of three devices, electromagnetic energy pattern and/or frequency.

There is also proposed a computer-implemented method for determining the handedness, with respect to gravity, of a plurality of hypothetical triangles forming a polygon mesh lying in a single plane, wherein each hypothetical triangle connects three devices together and each forms a different face of the polygon mesh, the computer-implemented method comprising: performing as previously described to determine a handedness of a first triangle of the mesh with respect to gravity; and determining, for each other hypothetical triangle of the mesh, a handedness of the hypothetical triangle, with respect to gravity, based on the handedness of the first triangle.

The single plane may be a non-vertical plane. In some examples, the single plane is a plane of a ceiling to which devices are connected and/or mounted. The single plane may be horizontal. In aspects, the single plane may be phrased as a planar plane.

There is also proposed a computer program product comprising computer program code means which, when executed on a computing device having a processing system, cause the processing system to perform all of the steps of any herein described method.

There is also proposed a processing system for defining the handedness, with respect to gravity, of a first hypothetical triangle connecting a set of three devices, the processing system being configured to, define a direction of gravity with respect to the first device from a gravitational sensor associated with the first device and comprised by the first device; obtain, from an electromagnetic detector arrangement associated with the first device of the set of three devices: a first indicator that indicates the relative direction of a second device, of the set of three devices, with respect to the first device, wherein the second device is configured to output electromagnetic energy detectable by the electromagnetic detector arrangement; and a second indicator that indicates the relative direction of a third device with respect to the first device, wherein the third device is configured to output electromagnetic energy detectable by the electromagnetic detector arrangement; and define the handedness of the first hypothetical triangle connecting the three devices with respect to gravity by processing the direction of gravity with respect to the first device, the first indicator and the second indicator.

There is also proposed a system comprising: the processing system previously described and at least one device of the set of three devices connected by the first hypothetical triangle, wherein the at least one device comprises at least the first device that comprises the processing system, and wherein the first device comprises the gravitational sensor.

There is also proposed a system comprising: the processing system previously described; and the set of three devices connected by the first hypothetical triangle.

There is also proposed a processing arrangement for determining the orientation, with respect to gravity, of a mesh of devices, wherein each device is configured to output electromagnetic energy and the mesh is formed of a plurality of hypothetical triangles that connect devices together, the processing arrangement comprising: the processing system previously described, wherein the first hypothetical triangle is one of the hypothetical triangles of the mesh; and a second processing system configured to determine, for each hypothetical triangle of the mesh, a handedness of the hypothetical triangle, with respect to gravity, based on the handedness of the first hypothetical triangle.

There is also proposed a system comprising: the processing arrangement previously described; and the mesh of devices.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates two possible orientations for a mesh of devices;

FIG. 2 illustrates an approach according to an embodiment;

FIG. 3 illustrates a method according to an embodiment;

FIG. 4 illustrates another method according to an embodiment; and

FIG. 5 illustrates a system.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for handling mirror symmetry and gravity ambiguity in a two-dimensional mesh of devices. A direction of gravity with respect to a first device, of a trio of devices, is determined. A relative direction of a second and third device with respect to the first device is then ascertained. The direction of gravity, and the relative directions of the first and third device, are then used to determine a handedness of a triangle connecting the three devices with respect to gravity. This handedness with respect to gravity can be propagated throughout the mesh of devices and used to eliminate mirror symmetry and gravity ambiguity in the mesh.

Embodiments are based on the realization that an additional potential degree of freedom in a mesh of devices can be eliminated or ascertained by establishing the handedness with respect to gravity of all triangles forming a mesh of devices.

Examples of herein disclosed embodiments may be employed in any scenario in which devices, positioned in a same plane, are to be commissioned. The devices may for example perform an auto-commissioning process, in which said handedness is relevant to be determined. Suitable scenarios include the commissioning of luminaires or light fixtures in a ceiling or connected ground. Another example could include a mesh of sprinklers for a garden or outdoor area or for a ceiling (e.g. fire sprinklers). Yet another example might include a set of speakers positioned at a same height within a room. Yet other examples for suitable devices include PIR sensors, fire sensors, sound level sensors and thermopile sensors, temperature/humidity sensors and so on. A combination of any previously described device or sensor could be used.

For the sake of the present disclosure, the term “counter-clockwise” is considered interchangeable with “anti-clockwise” or “anticlockwise”. The term “above” means higher than with respect to gravity.

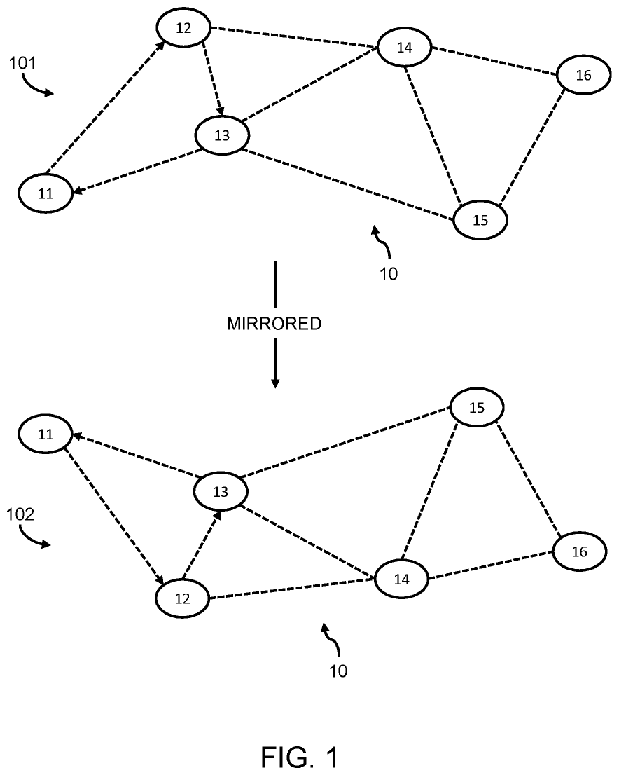

FIG. 1 demonstrates a problem resolved by disclosed embodiments. FIG. 1 illustrates a 2D mesh 10 of devices 11, 12, 13, 14, 15, 16, which are interconnected by hypothetical triangles. Each triangle connects three devices together, and abuts at least one other triangle. The triangles do not overlap one another, such that the hypothetical triangles represent faces of a polygon mesh connecting the devices together.

Approaches for determining a shape of the mesh 10, i.e. setting up the hypothetical triangles, are well-established in the art. Purely by way of example, the shape of the mesh of devices could be derived based on RSSI, time of flight, or similar distance-responsive measures between the devices. It is not necessary to describe these approaches in detail, as are they are well-established. Such a description shall be omitted for the sake of concision.

However, it is herein recognized that one drawback of known approaches for determining a shape of the mesh is that the chirality or handedness of the triangles and/or mesh in such a shape would be unknown. This means that is it not possible to accurately commission the mesh of devices, i.e. to establish a spatial and positional relationship between the devices.

This drawback is perhaps best illustrated by FIG. 1, which illustrates two scenarios 101, 102 for a mesh 10 of devices lying in a single plane. In each scenario, the direction of gravity is held constant (e.g. goes into the page). It can also be seen how the shape of the mesh in each scenario is identical. However, the mesh is mirrored about one of the devices between the two scenarios, whilst retaining the same shape. Thus, it is possible to flip/change the handedness or chirality of the mesh by mirroring the mesh across a line lying within the single plane.

There is therefore a degree of freedom in the positioning of the mesh that has not been resolved, which prevents or bottlenecks automated commissioning of the mesh of devices 10.

Proposed embodiments overcome this issue by establishing the handedness or chirality of the triangles with respect to gravity. In this way, it is possible to distinguish in which of the two mirrored orientations (illustrated in scenarios 101, 102) the mesh lies. This approach avoids, for instance, a need to individually determine a direction of gravity for each device (e.g. using a respective gravitational sensor).

Proposed embodiments define each triangle as a path that starts at a first device, moves to a second device, then moves to a third device before returning to the first device. For each of later reference, triangles may be defined using the notation A-B-C, which indicates a triangle defined by a path that starts at device A, then moves to device B, then moves to device C before reverting to device A.

As an example, FIG. 1 illustrates (for each scenario) a first triangle or path 110 that moves from a first device 11 to a second device 12, from the second device 12 to a third device 13 and then from the third device 13 to the first device 11. This first triangle would have notation 11-12-13. It can be seen how in the first scenario 101, the path/triangle 11-12-13 has clockwise handedness or chirality. In the second scenario 102, the path/triangle 11-12-13 has counter-clockwise handedness or chirality.

Thus, the handedness of a path with respect to gravity (in the illustrated example: into the page) can define or characterize in which orientation the mesh of devices containing said path is positioned.

It is also herein recognized that, due to the nature of the polygon mesh formed of the plurality of hypothetical triangles, once the handedness of one triangle is determined, it is possible to determine the handedness of all other triangles in the polygon mesh (i.e. through simple propagation techniques). This is possible because the shape of the mesh of devices is known and fixed.

For instance, if a first triangle is defined as 11-12-13, and a second triangle is defined by 12-13-14, then the second triangle, in the first scenario 101, must have counter-clockwise handedness or chirality and, in the second scenario 102, must have clockwise handedness or chirality.

Similarly, if the first triangle is defined as 11-12-13, but the second triangle is instead defined by 13-12-14, then the second triangle, in the first scenario 101, must have clockwise handedness or chirality and, in the second scenario 102, must have counter-clockwise handedness or chirality.

The proposed approach thereby facilitates identification of the relative position of all devices with respect to other devices in a same hypothetical triangle of the mesh. If the direction of gravity with respect to one of the devices is known, then the overall orientation of the mesh with respect to gravity can be easily determined, to thereby eliminate mirror symmetry and gravity ambiguity from the mesh 10 of devices.

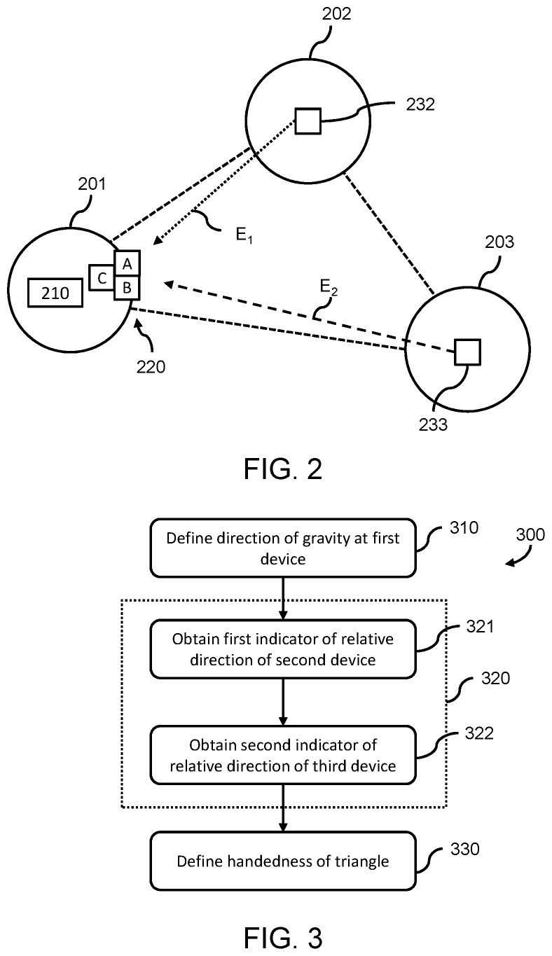

FIG. 2 illustrates one approach for defining the handedness, with respect to gravity, of a hypothetical triangle 201-202-203 connecting three devices 201, 202, 203. This approach may be adopted by a computer-implemented method and/or processing system according to various embodiments of the invention.

The proposed approach defines a handedness of the triangle, with respect to gravity, within a plane having a upper surface/face whose normal is angled >90° and <=180° (e.g. 180°) with the direction of gravity and a lower surface/face whose normal is angled >=0° and <90° (e.g. 0°) with the direction of gravity. The handedness is defined from a top view of this plane, i.e. a view from a position above the plane and looking in the direction of gravity.

Each device 201, 202, 203 may be a device configured for commissioning, e.g. into the internet of things. Thus, each device may comprise a communication module (not shown) for wired/wireless communication and external control or initiating. In some examples, each device is a luminaire, and comprising a light emitting element (e.g. an LED arrangement) configured to output light. The communication module may receive communications for controlling one or more properties of the light emitting element. The one or more properties may include a color, a temperature, an intensity, an angle, a frequency, a spread and so on of light output by the light emitting element.

A direction of gravity for at least one of the devices 201 (a first device 201) is defined.

In some examples, this is performed based on a-priori knowledge. For instance, if it is known that the devices can only be installed in certain orientations (e.g. ceiling troffers), then the direction of gravity with respect to the device can be ascertained or defined in advance.

As mentioned, defining the direction of gravity is performed using a gravitational sensor 210, which is associated with the first device.

The gravitational sensor 210 is configured to determine a direction of gravity with respect to the first device 201. Suitable examples of gravitational sensors include an accelerometer or gravimeter.

The first device comprises an electromagnetic detector arrangement. The electromagnetic detector arrangement 220 is configured to determine/obtain: a first indicator that indicates the relative direction of a second device, of the set of three devices, with respect to the first device; and a second indicator that indicates the relative direction of the third device with respect to the first device. The electromagnetic detector arrangement 220 thereby acts as an angular detector.

Thus, the electromagnetic detector arrangement 220 effectively triangulates the second and third device in the triangle. In particular, the electromagnetic detector arrangement 220 determines a relative positioning, from the perspective of the first device, of the second and third devices to one another (e.g. which of the second and third devices are positioned on the left and right within a 180° viewpoint).

The electromagnetic detector arrangement may be positioned on or inside the first device. For instance, if the first device is a luminaire positioned in a ceiling, the electromagnetic detector arrangement may be positioned to lie above the ceiling level. In such an example, the first device may comprise small holes or partially/fully transparent areas to allow electromagnetic energy to pass towards the electromagnetic detector arrangement.

The second 202 and third 203 devices are both configured to output electromagnetic energy that can be detected or sensed by the electromagnetic detector arrangement. Accordingly, the second device may comprise a first electromagnetic outputting element 232 (outputting first electromagnetic energy E₁) and the third device may comprise a second electromagnetic outputting element 233 (outputting second electromagnetic energy E₂).

In the illustrated example, the electromagnetic detector arrangement 220 comprises (at least) three electromagnetic detectors A, B, C, positioned approximately or substantially in a same plane. This plane is the same plane in which the hypothetical triangle 201-202-203 lies.

Each detector of the arrangement 220 may be configured to generate a signal responsive to a strength of the received electromagnetic energy E₁. E₂ output by each other device 202, 203, multiplied by a different angular response factor. Thus, each detector is configured or positioned to have a different angular response, so that the magnitude of a measurement of incoming electromagnetic energy emitted from a same source is different for each electromagnetic detector. This facilitates triangulation of the source of incoming electromagnetic energy (i.e. the second and third devices). The angular response of each detector is such that the magnitude of a measurement (by the detector) of incoming electromagnetic energy changes depending upon the direction of the incoming electromagnetic energy.

In some examples, the detectors may be configured to receive electromagnetic energy from the same number of directions, but where (for each of a plurality of angle of arrivals) the sensitivity of each sensor varies. Thus, each detector has an angular sensitivity pattern, in which the angular sensitivity patterns of different detectors is different. However, the spread of sensitivities should have some overlap with neighboring sensors. The ratios of the sensing signals generated by each detector exhibiting the pattern/frequency from each of the transmitters can then be processed to determine each angle of arrival.

For instance, the detectors could be arranged in a vertical line, and be directed to 0°, 120°, and 240° about a vertical axis. These directions represent the maximum response direction. If each detector has a symmetric angular sensitivity drop that zeros at +120° and −120° with respect to this maximum response direction, and has zero sensitivity beyond these angles, the angle of arrival of electromagnetic energy to the detector arrangement 220 can be readily retrieved.

It will be appreciated that the signals of all electromagnetic detectors in the arrangement 220 may be processed to generate, for each of the second and third devices, intensity ratios of the detector signals. These intensity ratios can be used to perform triangulation of the second and third devices with respect to the first device, according to well-established principles of triangulation.

Although the electromagnetic detector arrangement comprises only three electromagnetic detectors in the illustrated example, it will be appreciated that the arrangement may comprise additional electromagnetic detectors, e.g. to improve angular accuracy or to compensate for restricted angular sensitivity of the sensors.

The previously described electromagnetic detector arrangement relies upon a triangulation mechanism for determining the relative direction of the second and third devices. Alternative examples may make use of a trilateration mechanism for determining the relative direction(s).

Alternatives to the illustrated electromagnetic detector arrangement will be apparent to the skilled person, such as a camera (which can detect a relative direction of emitted light), a quadrant detector or an appropriately configured position sensitive device. The precise nature of the electromagnetic detector arrangement may depend upon the nature and/or frequency of the electromagnetic energy.

To discriminate between electromagnetic energy emitted by the second and third devices, the second and third devices may be configured to output, via the electromagnetic outputting elements, electromagnetic energy having a unique (to the set of three devices) pattern and/or frequency. For instance, different devices may output electromagnetic energy carrying an (optionally encoded) identifier, e.g. via CDMA or the like. As another example, frequency division multiplexing may be used to distinguish different emissions of electromagnetic energy from one another.

Alternatively, the second and third devices may be configured to emit electromagnetic energy at different points in time. This may be performed, for instance, using a time-division multiplexing approach or a queueing system.

The first and second indicators facilitate determination of the handedness of the hypothetical triangle 201-202-203. This is because the first and second indicators facilitate identification of the left-right order of the second and third devices with respect to the front of the electromagnetic detector arrangement, and thereby the handedness of the triangle 201-202-203.

The handedness is defined with respect to a direction of gravity, which is determined for the first device. In particular, the handedness is defined from a viewing direction parallel to a gravitational direction. This facilitates identification of the orientation of the triangle 201-202-203 with respect to gravity, thereby eliminating mirror symmetry and gravity ambiguity from the triangle connecting the set of three devices.

The electromagnetic detector arrangement 220 and the electromagnetic outputting elements 232, 233 complement one another, e.g. to detect and output respectively the same type of electromagnetic energy. Suitable examples of electromagnetic energy include visible light, radio waves, microwaves and so on. In some examples, the electromagnetic energy is emitted according to a predefined communication protocol or standard, e.g. according to a protocol under the IEEE 802.11 protocol, under the IEEE 802.15.4 protocol, Bluetooth® or a mobile telephony standard (e.g. 3G, 4G, 5G and so on).

In preferable examples, the electromagnetic detector arrangement 220 and the electromagnetic outputting elements are configured to make use of visible light. This is particularly advantageous in examples where the devices are lighting elements or luminaries, which would typically be positioned to lie in a same plane (e.g. on the ceiling). In these examples, the electromagnetic detector arrangement may comprise a plurality of photodetectors, e.g. photodiodes or photoresistors.

It has previously been explained how once the handedness or chirality of one triangle (in a mesh) is determined, then this information can be propagated throughout the mesh to determine the handedness, with respect to gravity, of all triangles in the mesh.

This information can be used to establish the most likely orientation of the full mesh of devices with respect to gravity.

Information on the chirality or handedness or chirality of all triangles could be used to generate or predict a get a top-view (or if desired bottom-view) map of the mesh of devices that can be used for commissioning.

By way of explanation, if the triangle 201-202-203 is determined to have clockwise chirality as illustrated, then it can be determined that, from the perspective of device 201, device 202 is positioned to the left of device 203 and, similarly, device 203 is positioned to the right of device 202.

As the handedness or chirality of all triangles in the mesh are known, it can be readily determined, for a particular device, the relative position of each other device in any triangles in which the particular device lies. In this way, a top-down view/map of the mesh can be readily determined.

The proposed approach for determining a chirality of a triangle using a detector arrangement (e.g. rather than through propagation of a determined chirality) could be performed for multiple triangles of the mesh.

If the process for determining a chirality of a triangle of devices (using a detector arrangement) is performed for multiple triangles of the mesh, then information on the handedness/chirality of all triangles and/or the map could also be used to correct and/or validate the shape of the mesh of devices, which has been previously derived or predicted. In particular, the shape of the mesh of devices may be updated if there are inconsistencies between different calculations of handedness for a same triangle.

It is noted that the proposed approach, whilst resolving one degree of freedom, leaves another degree of freedom (rotation about the vertical axis) unresolved. This further degree of freedom could be resolved using another approach, e.g. by determining an absolute position of two devices in the mesh, to thereby fix or determine the absolute position of the mesh.

The operation of the devices may be controlled by a processing arrangement (not shown). The processing arrangement is able to send information to, and receive information from, the mesh of devices. The processing system may perform the necessary actions for determining the handedness of the triangle (e.g. based on information received from the devices).

FIG. 3 illustrates a method 300 for defining the handedness, with respect to gravity, of a hypothetical triangle connecting three devices. The method is computer-implemented.

The method 300 comprises a step 310 of defining a direction of gravity with respect to the first device. Step 310 may comprise obtaining, from a gravitational sensor associated with a first device of the set of three devices, a direction of gravity with respect to the first device.

The method 300 further comprises a process 320 of obtaining, from an electromagnetic detector arrangement associated with the first of the set of three devices: a first indicator that indicates the relative direction of a second device, of the set of three devices, with respect to the first device, wherein the second device is configured to output electromagnetic energy detectable by the electromagnetic detector arrangement; and a second indicator that indicates the relative direction of the third device with respect to the first device, wherein the third device is configured to output electromagnetic energy detectable by the electromagnetic detector arrangement.

The first indicator may be obtained in a first sub-step 321 and the second indicator may be obtained in a second sub-step 322.

The method 300 further comprises a step 330 defining the handedness of a hypothetical triangle connecting the three devices with respect to gravity by processing the direction of gravity with respect to the first device, the first indicator and the second indicator. Approaches for defining a handedness using the first and second indicators have been previously described, as have suitable examples of the first and second indicators.

Method 300 may be performed by a processing system able to communicate with at least the first device in the mesh of devices, e.g. to receive the first indicator, second indicator and the direction of gravity. In particular, method 300 may be performed by a processing system that is configured for (automated) commissioning of the mesh of devices, e.g. to communicate with all devices in the mesh of devices.

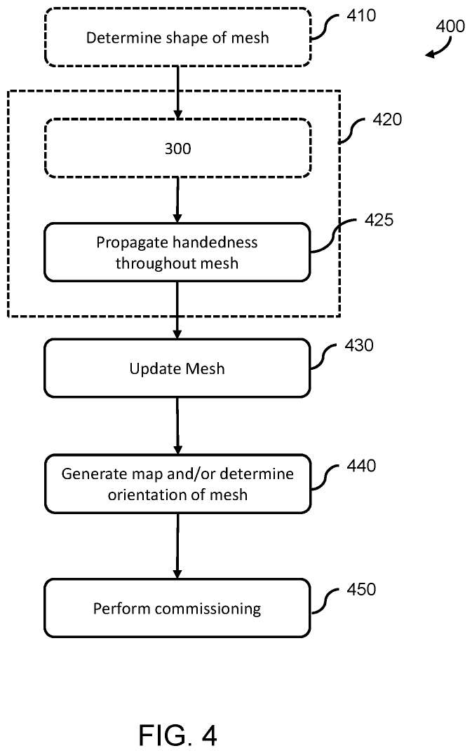

FIG. 4 illustrates a method 400 for commissioning a mesh of devices according to an embodiment. The method is computer-implemented.

The method 400 comprises a step 410 of determining a shape of the mesh of devices. Approaches for determining a shape of a mesh of devices are well-established in the art. Commonly, such approaches include measuring a mutual signal strength (RSSI) between all of the devices, to form a link strength matrix. A multidimensional scaling (MDS) technique can then be performed to convert the link strength matrix to generate a 2D mesh of triangles that links all devices together. Each vertex of the 2D mesh represents a different device.

The 2D mesh is thereby formed of a plurality of hypothetical triangles, wherein each hypothetical triangle connects three devices together and each forms a different face of the polygon mesh. Thus, different triangles abut one another without overlapping.

The method 400 may then perform a process 420 for determining the handedness, with respect to gravity, of the triangles of the mesh. The process 420 is itself an embodiment.

Process 420 comprises performing method 300, previously described, to determine a handedness of a first triangle of the mesh with respect to gravity. Process 420 then performs a step 425 of determining, for each other hypothetical triangle of the mesh, a handedness of the hypothetical triangle, with respect to gravity, based on the handedness of the first triangle.

Step 425 is achieved by propagating the determined handedness of the first triangle throughout the remainder of the mesh. Approaches for performing propagation would be readily apparent to the skilled person.

For improved redundancy, method 300 may be performed a plurality of times for multiple different triangles of the mesh. In particular, there may be more than one device having a gravitational sensor and an electromagnetic detector arrangement to facilitate identification of the handedness of other triangles in the mesh. Step 425 may be adapted to propagate all determined handedness throughout the network.

The method 400 may then perform (optional) step 430 of updating or correcting the mesh structure based on the determined handedness. In particular, if there are any inconsistencies in the calculations of the handedness, then the shape of the structure may be corrected.

The method 400 then performs step 440 of determining or predicting an orientation of the mesh with respect to gravity. This can be achieved, as the handedness of all triangles with respect to gravity has been previously determined, such that a most likely orientation of the mesh can be readily derived.

Step 440 may alternatively or additionally comprise generating a top-view (or if desired bottom-view) map of the mesh of devices. A top view is a view from above the mesh of devices in the direction of gravity. This can be achieved, because the relative handedness of all of the triangles effectively defines a relative positioning between the devices. As a shape of the mesh is already known, this facilitates accurate positioning of the devices, with respect to one another, upon a map.

In some examples, the method may be configured to further comprise a step of deriving, from the determined handedness of triangles in the mesh with respect to gravity, an orientation (with respect to gravity) of any device that contains an angular sensor and is in a triangle of the mesh with other two devices that output identifiable electromagnetic energy.

This is possible because an agreement between the relative directions of the other two devices derived using the angular sensor and the relative directions defined by the handedness of the triangle indicates that the angular sensor (and therefore device) is aligned with gravity. A disagreement or mismatch indicates that the angular sensor is inverted with respect to gravity. This facilitates identification of the orientation of the device with respect to gravity.

The method 400 then moves to a step 450 of commissioning the devices. Approaches for commissioning a set of devices are well-established in the art, and may comprise connecting appropriate inputs and outputs of each device to relevant elements of application program interfaces (APIs) and user interfaces.

The commissioning of the devices may be based upon the orientation of the devices, the mesh and/or the map of the mesh of the devices. This provides valuable information for automating appropriate commissioning, by eliminating ambiguity regarding mirror symmetry or gravitational direction.

Method 400 may be performed by a processing system able to communicate with each device in the mesh of devices. Suitable wireless communication protocols that may be used to perform this communication include an infrared link, ZigBee, Bluetooth, a wireless local area network protocol such as in accordance with the IEEE 802.11 standards, a 2G, 3G or 4G telecommunication protocol, an ultrasonic protocol, and so on. Other formats will be readily apparent to the person skilled in the art.

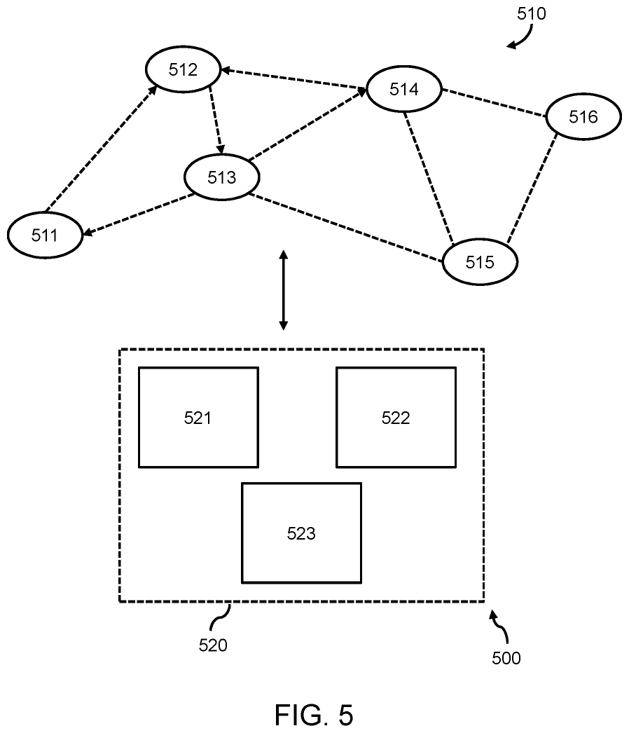

FIG. 5 illustrates a system 500 according to an embodiment. The system 500 comprises a mesh 510 of devices 511-516 and a processing system arrangement 520. The processing arrangement is also one embodiment.

The mesh 510 comprises three or more devices, which can form a polygon mesh of one or more hypothetical triangles, in which different triangles abut one another and do not overlap. To facilitate determination of the mesh 510, for each device, it should be possible to determine a relative distance between that device and at least two other devices (e.g. using an RSSI approach).

The mesh 510 of devices lie in a single plane, i.e. to form a two-dimensional mesh. This single plane is a non-vertical plane. In particular, the single plane may be horizontal and/or a plane of a ceiling to which devices are connected and/or mounted. The processing arrangement 520 comprises a first processing system 521 and a second processing system 522. In some examples, the first and second processing systems are one and the same, in other examples (as illustrated), they are two separate entities. The processing arrangement is communicatively coupled to the mesh of devices, so as to be able to send information to, and receive information from, the mesh of devices.

The first processing system is configured for defining the handedness, with respect to gravity, of a hypothetical triangle 511-512-513 connecting three devices 511, 512, 513.

The first processing system 521 is configured to define a direction of gravity with respect to the first device. This may be performed by, for example, obtaining the direction of gravity from a gravitational sensor associated with a first device of the set of three devices.

The first processing system 521 is further configured to obtain, from an electromagnetic detector arrangement associated with the first 511 of the set of three devices: a first indicator that indicates the relative direction of a second device 512, of the set of three devices, with respect to the first device; and a second indicator that indicates the relative direction of the third device 513 with respect to the first device. The first processing system 521 is further configured to determine the handedness of the first hypothetical triangle with respect to gravity by processing the direction of gravity with respect to the first device, the first indicator and the second indicator.

Thus, the first processing system performs or carries out the method 300 described with reference to FIG. 3.

Preferably, each of the second and third devices is configured to be operable to output a unique, to the set of three devices, electromagnetic energy pattern and/or frequency and the electromagnetic detector arrangement is configured to distinguish the electromagnetic patterns and/or frequencies from one another. If the electromagnetic energy is light, this can be performed by appropriate encoding of light patterns.

In some examples, each of the second and third devices is configured to be operable in at least two modes, including: a commissioning mode, in which the device outputs the unique, to the set of three devices, electromagnetic energy pattern and/or frequency; and a run mode, in which the device is able to not output the unique, to the set of three devices, electromagnetic energy pattern and/or frequency. In particular, when operating in the run mode, the device may be prevented from outputting the unique, to the set of three devices, electromagnetic energy pattern and/or frequency.

The mode in which a device operates may be controlled by the processing arrangement 520, e.g. by the first processing system 521. The processing arrangement 520 may control the device(s) to enter the run mode responsive to (i.e. only upon completion of) determining the handedness of all triangles of the mesh and/or predicting the orientation of the mesh with respect to gravity.

The second processing system 522 is configured to determine, for each hypothetical triangle of the mesh, a handedness of said hypothetical triangle, with respect to gravity, based on the handedness of the first hypothetical triangle. This may be performed by propagating the handedness of the first hypothetical triangle 511-512-513 throughout the mesh 510.

It has previously been described how, for improved redundancy, approaches could be adapted in which the handedness of multiple different triangles of the mesh are determined (e.g. by the first processing system). In particular, there may be more than one device for which a direction of gravity can be independently defined (e.g. from a gravitational sensor) and having an electromagnetic detector arrangement to facilitate identification of the handedness of other triangles in the mesh.

Conflicts between different determined handedness of triangles in the mesh, e.g. generated by propagating a handedness of different independently determined handedness of triangles, can be automatically resolved, e.g. by restructuring the shape of the mesh. This provides an improved mesh shaping mechanism.

However, it is not essential to independently define the direction of gravity for all devices in the mesh of devices comprises a gravitational sensor. It is herein recognized that it is not necessary for all devices to comprise such independently directions of gravity (e.g. separate gravitational sensors) whilst still achieving highly accurate identification of the handedness of all triangles and the orientation of the mesh. This avoids the need for expensive gravitational sensors in all devices of the mesh.

It is possible to derive or predict, from the determined handedness of triangles in the mesh with respect to gravity, an orientation of any device in a triangle that contains an angular sensor when the other two devices of that triangle output identifiable electromagnetic energy.

The angular sensor can be used to identify a relative direction of the other two devices in the triangle. If the relative directions match expected relative directions (from the known handedness of the triangle), this means that the angular sensor (and therefore the device) is aligned with respect to gravity. If the relative directions do not match expected relative directions (from the known handedness of the triangle), this means that the angular sensor (and therefore the device) is inverted with respect to gravity.

By way of example, assume a scenario in which: gravity is in a direction into the page for FIG. 5; device 514 comprises an angular sensor and devices 512 and 513 output identifiable electromagnetic energy. If the orientation of device 514 is aligned with gravity, then the relative direction of device 512, detected by the angular sensor, will be to the right of device 513 (based on the illustrated handedness of the triangle 513-514-512). Similarly, if the orientation of device 514 is inverted with respect to gravity, then the relative direction of device 512, detected by the angular sensor, will be to the left of device 513 (based on the illustrated handedness of the triangle 513-514-512).

Thus, there may be a third processing system 523 configured to determine, for any device comprising an angular sensor located in a triangle of the mesh in which the other two devices of that triangle output identifiable electromagnetic energy, an orientation of said device with respect to gravity.

This provides an approach for determining the orientation of a device with respect to gravity without the need for a direct gravitational sensor (e.g. an accelerometer or gravimeter).

Each device in the mesh of devices may, for instance, be a luminaire or light emitting element. The electromagnetic energy output by the second and third device may, for instance, be light energy. The proposed approach is particularly suitable for luminaires or light emitting elements, as existing features or characteristics of such elements (e.g. the emitting light) could be exploited to reduce cost.

However, embodiments are not limited to luminaires or light emitting elements. Rather, each device may comprise one or more of the following: PIR sensors, fire sensors, sound level sensors and thermopile sensors, temperature/humidity sensors, light emitting elements, speakers, sprinklers and so on. Thus, each device may form any suitable IoT device.

Examples of suitable devices have been described with reference to FIG. 2, and could be employed in the system of FIG. 5.

Ordinal numbers (e.g. “first”, “second” and so on) have been used purely to distinguish different elements from one another for the sake of clarity, and reference to a non-“first” (e.g. “second” or “third”) element does not necessitate that a “first” element be present. The skilled person would be capable of relabeling any such elements as appropriate (e.g. relabeling a “second” element as a “first” element if only the second element is present).

The skilled person would be readily capable of developing a processing system for carrying out any herein described method. Thus, each step of the flow chart may represent a different action performed by a processing system, and may be performed by a respective module of the processing system.

Any herein described processing system can be implemented in numerous ways, with software and/or hardware, to perform the various functions required. A processor is one example of a processing system that employs one or more microprocessors that may be programmed using software to perform the required functions. A processing system may however be implemented with or without employing a processor, and also may be implemented as a combination of dedicated hardware to perform some functions and a processor (e.g., one or more programmed microprocessors and associated circuitry) to perform other functions.

Examples of processing system components that may be employed in various embodiments of the present disclosure include, but are not limited to, conventional microprocessors, application specific integrated circuits (ASICs), and field-programmable gate arrays (FPGAs).

In various implementations, a processor or processing system may be associated with one or more storage media such as volatile and non-volatile computer memory such as RAM, PROM, EPROM, and EEPROM. The storage media may be encoded with one or more programs that, when executed on one or more processors and/or processing systems, perform the required functions. Various storage media may be fixed within a processor or processing system or may be transportable, such that the one or more programs stored thereon can be loaded into a processor or processing system.

It will be understood that disclosed methods are preferably computer-implemented methods. As such, there is also proposed the concept of a computer program comprising code means for implementing any described method when said program is run on a processing system, such as a computer. Thus, different portions, lines or blocks of code of a computer program according to an embodiment may be executed by a processing system or computer to perform any herein described method. In some alternative implementations, the functions noted in the block diagram(s) or flow chart(s) may occur out of the order noted in the figures. For example, two blocks shown in succession may, in fact, be executed substantially concurrently, or the blocks may sometimes be executed in the reverse order, depending upon the functionality involved.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfill the functions of several items recited in the claims. If a computer program is discussed above, it may be stored/distributed on a suitable medium, such as an optical storage medium or a solid-state medium supplied together with or as part of other hardware, but may also be distributed in other forms, such as via the Internet or other wired or wireless telecommunication systems. If the term “adapted to” is used in the claims or description, it is noted the term “adapted to” is intended to be equivalent to the term “configured to”. Any reference signs in the claims should not be construed as limiting the scope.

1. A computer-implemented method for determining the handedness, with respect to gravity, of a hypothetical triangle connecting a set of three devices,
wherein the handedness, with respect to gravity, is a handedness with respect to a view from a position vertically above the hypothetical triangle and looking in the direction of gravity;
wherein a hypothetical triangle is defined by a path that starts at the first device, moves to the second device, moves to the third device before reverting back to the first device, and
wherein the handedness of the hypothetical triangle defines whether this path moves clockwise or counter-clockwise within a plane containing the triangle;
wherein the computer-implemented method comprises:
defining a direction of gravity with respect to a first device of the set of three devices from a gravitational sensor associated with the first device and comprised by the first device;
obtaining, from an electromagnetic detector arrangement associated with the first device of the set of three devices:
a first indicator that indicates the relative direction of a second device, of the set of three devices, with respect to the first device, wherein the second device is configured to output electromagnetic energy detectable by the electromagnetic detector arrangement; and
a second indicator that indicates the relative direction of a third device with respect to the first device, wherein the third device is configured to output electromagnetic energy detectable by the electromagnetic detector arrangement; and
determining the handedness of the hypothetical triangle with respect to gravity by processing the direction of gravity with respect to the first device, the first indicator and the second indicator.

2. The computer-implemented method of claim 1, wherein the second and third devices each comprises one or more light emitting elements and the electromagnetic detector arrangement associated with the first device is a light sensitive arrangement.

3. The computer-implemented method of claim 1, wherein either:
the second and third devices each comprises one or more radio frequency emitting elements and the electromagnetic detector arrangement associated with the first device is a radio sensitive arrangement; or
the second and third devices each comprises one or more microwave frequency emitting elements and the electromagnetic detector arrangement with the first device is a microwave sensitive arrangement.

4. The computer-implemented method of claim 1, wherein the electromagnetic detector arrangement associated with a first device comprises a set of three or more electromagnetic detectors configured or positioned to have a different angular response, so that the magnitude of a measurement of incoming electromagnetic energy emitted from a same source is different for each electromagnetic detector.

5. The computer-implemented method of claim 1, wherein both the second device and third device are configured to be operable to output a unique, to the set of three devices, electromagnetic energy pattern and/or frequency and the electromagnetic detector arrangement is configured to distinguish the electromagnetic patterns and/or frequencies from one another.

6. The computer-implemented method of claim 5, wherein both the second device and third device are configured to be operable in at least two modes, including:
a commissioning mode, in which the device outputs the unique, to the set of three devices, electromagnetic energy pattern and/or frequency; and
a run mode, in which the device is able to not output the unique, to the set of three devices, electromagnetic energy pattern and/or frequency.

7. (canceled)

8. (canceled)

9. (canceled)

10. (canceled)

11. (canceled)

12. A processing system for determining the handedness, with respect to gravity, of a first hypothetical triangle connecting a set of three devices, the processing system being configured to:
define a direction of gravity with respect to the first device from a gravitational sensor associated with the first device and comprised by the first device;
obtain, from an electromagnetic detector arrangement associated with the first device of the set of three devices:
a first indicator that indicates the relative direction of a second device, of the set of three devices, with respect to the first device, wherein the second device is configured to output electromagnetic energy detectable by the electromagnetic detector arrangement; and
a second indicator that indicates the relative direction of a third device with respect to the first device, wherein the third device is configured to output electromagnetic energy detectable by the electromagnetic detector arrangement; and
determine the handedness of the first hypothetical triangle connecting the three devices with respect to gravity by processing the direction of gravity with respect to the first device, the first indicator and the second indicator.

13. A system comprising:
the processing system of claim 12; and
at least one device of the set of three devices connected by the first hypothetical triangle, wherein the at least one device comprises at least the first device which comprises the processing system, and wherein the first device comprises the gravitational sensor.

14. (canceled)

15. (canceled)
